(19) United States
(12) Patent Application Publication
(10) Pub. No.: US 2024/0020472 A1
(43) Pub. Date: Jan. 18, 2024

(54) SYSTEM AND METHOD FOR PROVIDING PREDICTIVE TEXT IN FOR INDIVIDUALS WORKING IN SPECIALIZED INDUSTRIES

(71) Applicants: Courtney Toombs, Long Island City, NY (US); Allison Phillips Toombs, Chicago, IL (US)

(72) Inventors: Courtney Toombs, Long Island City, NY (US); Allison Phillips Toombs, Chicago, IL (US)

(21) Appl. No.: 18/222,145

(22) Filed: Jul. 14, 2023

Related U.S. Application Data
(60) Provisional application No. 63/389,659, filed on Jul. 15, 2022.

(51) Int. Cl. G06F 40/274

(52) U.S. Cl. CPC G06F 40/274; G06F 3/04895

(57) ABSTRACT

The present invention is a method and system for providing suggested text in a digital communication using a mobile device. The mobile device includes a user interface with a keyboard and a ribbon. The ribbon includes user-readable and/or user-selectable fields. The system utilizes at least a first dictionary and a second dictionary. The first dictionary is a standard dictionary, and the second dictionary is a dictionary specific to a specialized profession or industry. The system utilizes an algorithm that receives user inputs and compares them to the entries in the first and second dictionaries. Based on the comparisons, the system provides one or more predictive and/or corrective suggestions. The system can provide additional weight to the second dictionary to favor words specific to a user's profession. The present invention reduces critical misspellings or miscommunications, along with the resulting effects of the errors.

### PRIORITY CLAIM

The present application claims priority to Provisional U.S. Patent Application Ser. No. 63/389,659, the disclosure of which is incorporated herein by reference in its entirety.

### FIELD OF THE INVENTION

The invention relates to system and method for providing predictive text and/or spell check for professionals sending communications while working in specialized industries in general, and more specifically to a keyboard enhancement (or stand-alone communication application) for a mobile device that predicts text while a user is typing while promoting words specific to the user's industry.

### BACKGROUND OF THE INVENTION

Accurate communication in specialty fields, such as, but not limited to the field of engineering, the medical field, and the legal field, is vital to completing most tasks. Miscommunication between professionals can have negative consequences. For example, errors in communication in the medical industry can be costly and even deadly.

Professionals frequently utilize mobile devices to carry out communications. Currently, standard keyboards on such devices frequently utilize features such as spell-check and offer predictive spelling. However, the features typically do not include words frequently used in the specialty industry and/or promote words that are more frequently used outside of the special industry. As a result, correctly spelled industry-specific words that are intended for a communication are often auto-corrected to a word utilized more frequently by individuals sending communications outside of the specialty field. Unless the sender of the message detects the unintended auto correct, or the recipient who receives a nonsensical message correctly interprets the original intent of the message, each unintended autocorrect can lead to a miscommunication.

Certain specialty industries, such as the medical industry have additional challenges that further complicate the issue due to privacy laws, such as HIPAA. The methods used to communicate must also comply with such laws.

The present invention is intended to address these and other shortcomings in the prior art.

### SUMMARY OF THE INVENTION

According to one aspect of the present invention, a system for providing suggested text to an end user performing digital communications is provided. The system includes a mobile device having a user interface with a keyboard and a ribbon. An algorithm compares user inputs to the entries in a first dictionary and a second dictionary. The first dictionary is a standard dictionary. The second dictionary is a primary specialty dictionary, preferably specific to the industry (e.g., the medical industry) in which the end user is operating within. Based on the matches found in the first and/or second dictionaries, the system determines whether to provide a corrective and/or predictive text suggestion. The resulting suggestions are provided to the user in a ribbon on the user interface. The system utilizes a scoring system to weight the suggestions in order to select the most likely word. The system may provide additional weight to the words in the second dictionary in order to promote industry-specific words of the end user.

According to another aspect of the invention, the digital communication can be of any type, including but not limited to an email, a text message, a direct message or a record keeping note.

According to a further aspect of the present invention, the suggestions may include more than one corrective suggestion.

According to an even further aspect of the present invention, the suggestions may include more than one predictive suggestion.

According to an even further aspect of the present invention, the suggestions may include at least one corrective suggestion and at least one predictive suggestion.

According to an even further aspect of the present invention, the system may include additional smart buttons that a user can select to, e.g., expand the information provided related to the suggestions.

According to an even further aspect of the present invention, the enhanced keyboard features can be used in combination with a standard keyboard available on most mobile devices, in a stand-alone app having communication or record keeping functions that utilize a keyboard, in combination with a third-party app that utilizes a keyboard for communication or record keeping, or the like.

One advantage of the present invention is that the predictive suggestions will include industry-specific words that are likely to reduce miscommunications.

Another advantage of the present invention is that the corrective suggestions will also include industry-specific words that are likely to reduce instances where an intended industry-specific word is corrected to a non-industry-specific word that could potentially lead to an unintended miscommunication.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is an image of a mobile phone screen displaying a user input screen with an enhanced keyboard of the present invention prior to any user inputs;

FIG. 1A is a diagrammatic image of one embodiment of the present invention showing a mobile device having a standard dictionary, primary specialty dictionary, secondary specialty dictionary and algorithm for providing corrective and predictive suggestions;

FIG. 2 is an image of a mobile phone screen displaying a user input screen with an enhanced keyboard of the present invention following the input of two (2) letters;

FIG. 3 is an image of a mobile phone screen displaying a user input screen with an enhanced keyboard of the present invention following the input of three (3) letters;

FIG. 4 is an image of a mobile phone screen displaying a user input screen of a beta test program utilizing the enhanced keyboard of the present invention following the input of four (4) letters and the display of several predictive suggestions in a ribbon;

FIG. 5 is an image of a mobile phone screen displaying a user input screen of a beta test program utilizing the enhanced keyboard of the present invention following the input of eight (8) letters and the several corrective suggestions in a ribbon;

FIG. 6 is an image of a mobile phone screen displaying a user input screen with an enhanced keyboard of the present invention following input from a user and the selection of a smart button to display enhanced corrective suggestions; and

FIG. 7 is an image of a mobile phone screen displaying a user input screen with an enhanced keyboard of the present invention following input from a user and the selection of a smart button to display enhanced predictive suggestions.

### DETAILED DESCRIPTION OF THE INVENTION

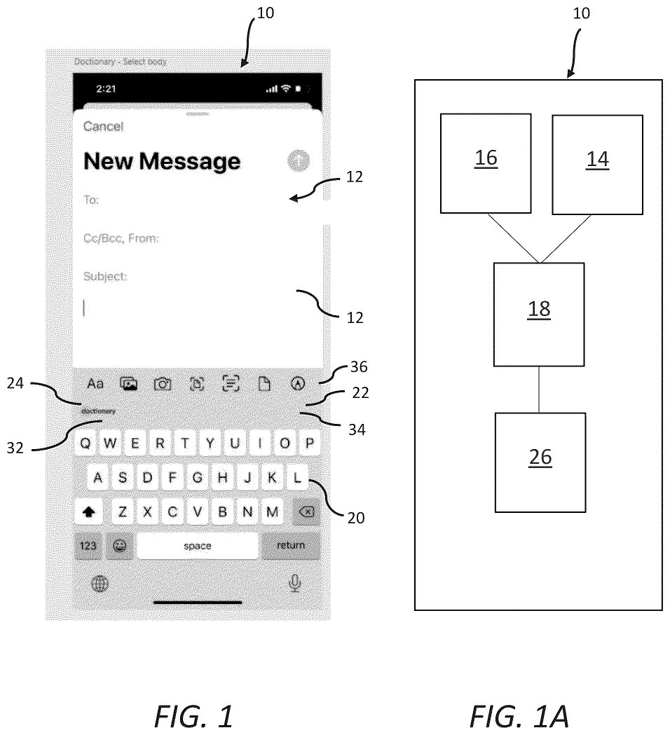

Referring to FIGS. 1-7, the present invention is a software program, such as a mobile device app, that modifies and enhances the standard keyboard in a communication device in to improve predictability of the words typed by the user working in a specialty industry. For the purposes of the present invention, the term “specialty industry” will refer to any industry where those working within the industry utilize a set of words that differs from the words typically used by those not working within the industry. Common examples of specialty industries include the medical, legal, and engineering industries. Communication devices that utilize the present invention can include, but are not limited to, any of the following: mobile devices, tablets, laptop computers, and desktop computers. In the preferred embodiment, the communication device 10 is a mobile phone and the software program is provided in the form of an app. The present invention can be used with any common type of mobile device 10 communication including, but not limited to, text messaging, emailing, and private or direct messaging. Additionally, the present invention could also have utility in other types of communications that are not directly sent to another individual or individuals, such as data entry, note taking and record keeping.

Referring to FIGS. 1-3, the present invention provides a user interface 12, at least one standard dictionary 14, a primary specialty dictionary 16, and an algorithm 18 that provides at least corrective and/or predictive text suggestions. The user interface 12 includes a keyboard 20 (or similar user input feature, such as a number pad), at least one ribbon 22, and optionally one or more specialty buttons 24. The present invention may also include a secondary specialty dictionary 26. In some embodiments, additional features, such bespoke data entry fields and pop-up windows 28 may also be provided. The communication devices 10 typically send and receive communications to/from other devices over the internet and can transmit data either wireless or in a wired setup. Additionally, the messages may be sent either encrypted or unencrypted depending on factors such as user preference, privacy laws and industry regulations. For example, as shown in FIG. 3, a visual cue, such as a box 30 around the keyboard or a change in color scheme can be used to signal to the user that the message is either encrypted or unencrypted. In some embodiments, the user may be able manually toggle between sending a communication in an encrypted or unencrypted manner. In other embodiments, the present invention may be programmed to identify key words or phrases that are often utilized in encrypted messages, and the system may prompt the user to confirm whether the message should be sent in an encrypted or unencrypted manner.

The present invention utilizes a standard dictionary 14. For the purposes of the present invention, a standard dictionary 14 is one that is intended for general use and is not one that is specific for a specialty industry. The language of the dictionary can vary depending on the intended end user. In a preferred embodiment, the standard dictionary is an English language dictionary, such as Merriam-Webster's Dictionary, the Oxford English Dictionary, The Random House Dictionary, or similar. The standard dictionary 14 may be accessed by the app either remotely (e.g., the standard dictionary is stored in the cloud) or locally (e.g., the standard dictionary is located in the local memory of the communication device 10). In some instances, the platform for app development may provide predictive text services using a standard dictionary (or similar). In these instances, the results provided by the platform for app development can also be incorporated in part, or in whole, in the present invention.

The present invention also utilizes a primary specialty dictionary 16. For the purposes of the present invention, a primary specialty dictionary 16 is one that is intended for use by professionals specific to a particular industry. In one example, the primary specialty dictionary 16 could be Black's Law Dictionary if the specialty industry practiced by the end user is the legal industry. In another example, the primary specialty dictionary 16 could be Merriam-Webster's Medical Dictionary in the event the intended end user is a practitioner communicating within the medical industry. The primary specialty dictionary 16 may be accessed by the app either remotely (e.g., the standard dictionary is stored in the cloud) or locally (e.g., the primary specialty dictionary 16 is located in the local memory of the communication device 10), and location of the primary specialty dictionary 16, in some embodiments, may differ from the standard dictionary 14. In the embodiment shown in FIG. 1A, the primary specialty dictionary 16 is loaded onto the local memory of the mobile device 10. The present invention can also have additional words or phrases manually added to the primary specialty dictionary 16 from time to time in order to add common abbreviations, slang, and/or common industry terminology that does not appear in a formal off-the-shelf dictionary.

In some embodiments, more than one specialty dictionary may be utilized. For example, in the event the end user practices a sub-specialty within the specialty industry, it may be advantageous to include access to one or more additional specialty dictionaries, such as a secondary specialty dictionary 26. In one example, the end user may be an orthopedic surgeon. Therefore, it would be advantageous to also include a secondary specialty dictionary 26 in addition to the primary specialty dictionary 16 that expands the end user's likely text vocabulary with an additional library of words specific to the end user's practice (e.g., orthopedic surgery). In the present example, it may be advantageous to also include a dictionary, or robust glossary of terms or even a defined subset of words from, e.g., the primary specialty dictionary 16, specific to the specialty as the secondary specialty dictionary 26. The above is simply one example that could be utilized in numerous specialty industries. The secondary specialty dictionary 26 (and any additional specialty dictionaries) may be accessed by the app either remotely (e.g., the secondary specialty dictionary 26 is stored in the cloud and accessed via the internet) or, as shown in FIG. 1A, locally (e.g., the secondary specialty dictionary 26 is located in the local memory of the communication device 10). The location of the secondary specialty dictionary 26, in some embodiments, may differ from the standard dictionary 14 and/or the primary specialty dictionary 16.

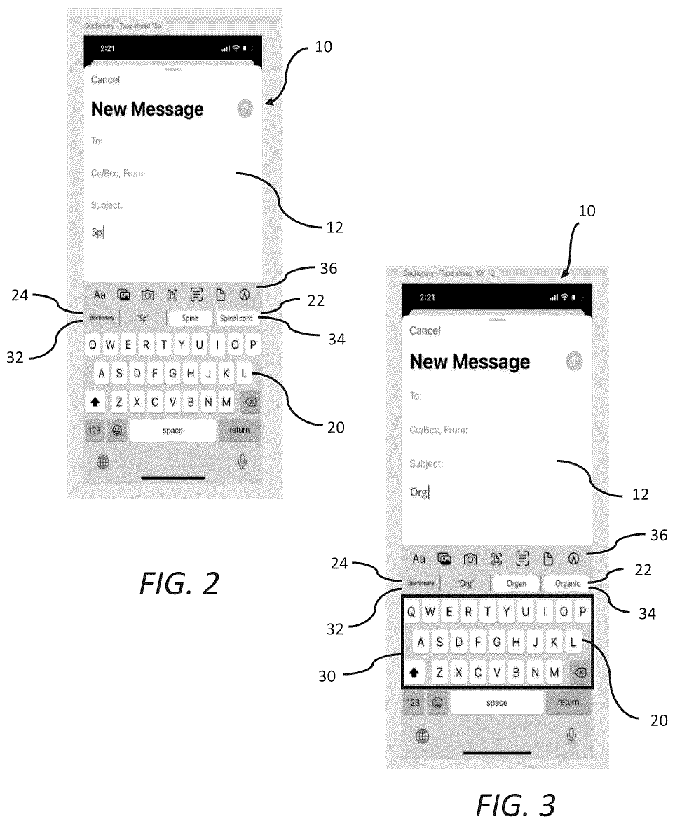

Referring now to FIGS. 1 and 2-3, the present invention includes a user interface 12. The user interface includes a keyboard 20. While the keyboard shown in FIGS. 1 and 2-3 is a standard English language “QWERTY” keyboard, it is known in the art to offer various keyboards with differing symbols (e.g., non-English language) or layouts depending on the preference of the end user. One or more ribbons 22 can be provided on the user interface 12. For the purposes of the present application, a ribbon 22 is an interactive region on the screen that includes user-readable and/or user-selectable fields 32. In the embodiment shown in FIGS. 2 and 3, there are two ribbons 22 provided, with both the first ribbon 34 and the second ribbon 36 being generally rectangular in shape. In some instances, the ribbon(s) 22 can be populated with predictive and/or corrective text suggestions from one or both of the standard 14 and/or specialty dictionaries 16, 26. In other instances, the ribbon(s) 22 may be populated with specialty buttons 24 or a combination thereof. In further instances, the app may alter the available function(s) in the ribbon(s) 22 depending on the actions of the user and/or results from the algorithm 18.

In some embodiments, the ribbon 22 may be provided generally adjacent the keyboard 20 (see e.g., FIG. 2). Although not shown, the ribbon 22 may alternatively be spaced away from the keyboard 20 in some embodiments. Positioning of the ribbon 22 may be determined by the app developer or may be user adjustable. In embodiments where the user interface 12 includes more than one ribbon 22, the ribbons 34, 36 may likewise be positioned adjacent or spaced away from the keyboard and/or the other ribbon(s) 34, 36.

As shown in, for example, FIGS. 2-5, the ribbon 22 is utilized to provide predictive and/or corrective suggestions based on partial input from the user into the keyboard 20. In the embodiment shown, when the user begins to provide input from the keyboard in the form of, e.g., letters, the app utilizes a pre-programmed algorithm 18 (discussed infra.) and begins to provide predictions and/or corrections based on what the user intended and/or is intending to type. One or more predictions and/or suggested corrections are provided in the ribbon 22. The predictions may be selected from, e.g., the standard dictionary 14, the primary specialty dictionary 16 and/or the secondary specialty dictionary 26. In situations where there is more than one ribbon 22, the app may provide corrective suggestions and predictive suggestions in separate ribbons 34, 36. In another example, in an embodiment with more than one ribbon 34, 36, the algorithm 18 may provide predictive text recommendations from one dictionary (e.g., the primary standard dictionary 16) in one ribbon, and predictive text recommendations from another dictionary (e.g., the primary specialty dictionary 16).

In order to provide predictive text suggestions, the algorithm 18 of present invention applies a weighting system to words in the various dictionaries 14, 16, 26 based on inputs from the user. For example, the weighting system of the algorithm 18 can use a variety of factors to provide suggested words including, but not limited to at least some of the following criteria: closeness in the match of the dictionary words to the user inputs; commonality of usage of the words in the dictionary; past user inputs; weighting applied to words from the standard dictionary; weighting applied to the words from the primary specialty dictionary; weighting applied to the words from the additional specialty dictionary; the length of the word (e.g., with shorter words receiving a greater weight); overall likelihood of word use; likelihood of word use in connection with the word or words immediately preceding (if any); and data from community experiences using the weighting system. In most embodiments, the weighting system is a dynamic system that learns and changes over time based on data collected from the individual user and app community experiences and/or manually inputted by the algorithm development team. One of skill in the art would realize that the exact selection of factors is highly subjective, and any combination of the above weighting factors can be combined with each other, or other factors listed above without departing from the spirit and scope of the present invention.

In addition, in order to provide corrective text suggestions, the algorithm 18 present invention provides a weighted score to words in the various dictionaries based on inputs from the user. For example, the weighted scoring system can use a variety of factors to provide suggested corrective words based on perceived errors including, but not limited to: character placement; character neighbor accuracy; overall likelihood of word use; past corrections made by the user; and past corrections made by the app community. One of skill in the art would realize that the exact selection of factors is highly subjective, and any combination of the above weighting factors can be combined with each other, or other factors listed above without departing from the spirit and scope of the present invention.

It should be noted that the weighting system for the same dictionary can also differ between users. For example, in the event that one end user is practicing in the medical profession and is cardiologist, the overall likelihood of word use ratings for each word in, e.g., the primary specialty dictionary 16 may carry different values versus when a second user that is also practicing in the medical profession and is an orthopedic surgeon.

In embodiments where predictive and/or corrective suggestions are provided by the algorithm 18 in a single ribbon, the present invention can also determine whether to provide predictive suggestions, corrective suggestions or a combination thereof. In the event that an insufficient number (e.g., zero) of exact matches to the user inputs are found in any of the dictionaries 14, 16, 26, then the algorithm 18 will provide only corrective suggestions. In the event that a sufficient number (e.g., three or more) of exact matches to the user inputs are located in any of the dictionaries 14, 16, 26, then the algorithm 18 will provide only predictive suggestions. In the event that a small number (e.g., one or two) exact matches to the user inputs are located in any of the dictionaries 14, 16, 26, then the algorithm 18 can provide both predictive and corrective solutions. One of skill in the art will understand that the above suggested numbers can be adjusted based on a number of factors including, but not limited to, the size of the user interface 12 of the mobile device 10.

In some embodiments, it may also be desirable for the algorithm 18 to also perform further clean up steps prior to providing corrective and/or predictive results. For example, adjusting casing of the suggested words has been shown to be advantageous in some situations. In one example, the algorithm 18 may make the suggested word have a first upper case letter to match what the user has entered on the keyboard 20, or the algorithm 18 may make a first letter upper case in the event that the predictive or corrective suggestion is a proper noun.

In addition, the results can be displayed in any suitable manner. For example, as mentioned above, one or more ribbons 34, 36 can be used to display the results. In addition, within a single ribbon 22, one or more predictive and/or corrective suggestions can be provided. For example, 3-4 suggestions (corrective or predictive) can usually fit in a readable format on a mobile device 10 such as a mobile phone. At least as many, or more, can often be readably displayed on larger mobile devices 10, such as tablets.

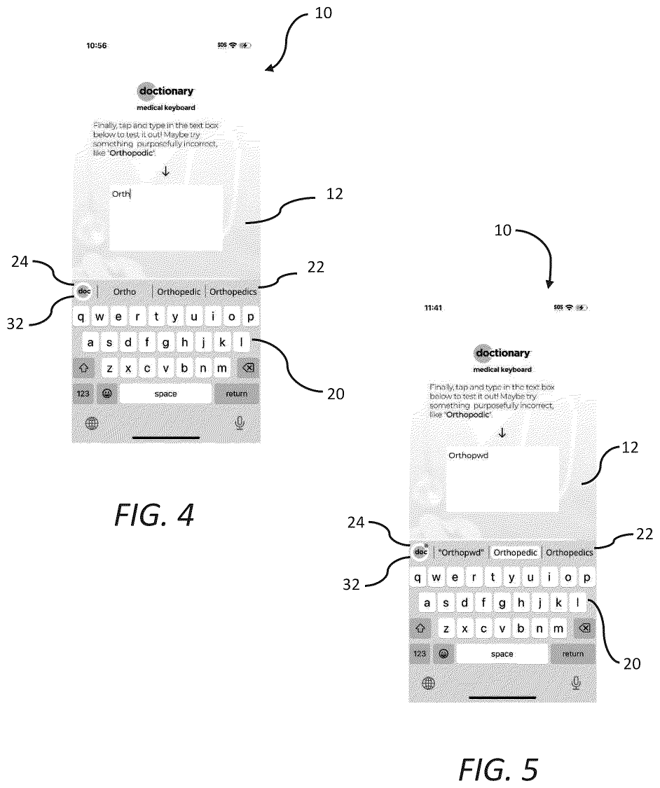

Referring now to FIG. 4, in one illustrative example of the manner in which the present invention operates, the present invention utilizes a single ribbon 22 that has the capability to provide both predictive and corrective text suggestions. The ribbon 22 has the ability to provide up to three (3) total suggestions at a time. In the present example, a publicly available resource for app developers was utilized to provide both predictive and corrective standard dictionary 14 suggestions. A bespoke listing of medical terminology was compiled to serve as primary specialty dictionary 16 for the present example. The primary specialty dictionary 16 was accessed remotely from the mobile device. In the present example, two (2) criteria are used to provide weight to the words in the specialty dictionary 16: 1) usage weight and 2) word length. The algorithm 18 iterates through the primary specialty dictionary 16 and searches for each word that starts with the letters entered by the user and applies a usage weight to each matching result. Usage weight is ascribed by its overall likelihood of use. In the present example, most words have been provided with a weight of 100 with a select number of words, such as “ortho”, being assigned with a weight of 150. Character weight is determined by lower character counts having a higher weight due to shorter words generally being more likely due to standard patterns of language. In the event the weight of two words is tied, the words are ordered in alphabetical order.

When a user types on the keyboard 20 of the user interface 12, for example, the letters “Orth”, the algorithm 18 provides results for the standard Apple Correction results from the Apple SDK and the Standard Apple Completion from Apple SDK. At the time of the test, the following results were provided.

The standard dictionary correction was provided as follows:
1. Found Standard Correction: “Oath”

The top 5 results from the standard dictionary predictive suggestions are as follows:
1. Standard Completion: Orthopedic
2. Standard Completion: Orthodox
3. Standard Completion: Orthodontist
4. Standard Completion: Orthodoxy
5. Standard Completion: Orthopedics

The following is a list of the first seventeen (17) matches and their weights from the primary specialty dictionary 16:
1. Line: orthergasia (UsageWeight:100; CharacterWeight:90)
2. Line: orthesis (UsageWeight:100; CharacterWeight:120)
3. Line: orthetic (UsageWeight:100; CharacterWeight:120)
4. Line: orthetics (UsageWeight:100; CharacterWeight:110)
5. Line: orthetist (UsageWeight:100; CharacterWeight:110)
6. Line: ortho (UsageWeight:150; CharacterWeight:150)
7. Line: orthoarteriotony (UsageWeight:100; CharacterWeight:40)
8. Line: orthobiologic (UsageWeight:100; CharacterWeight:70)
9. Line: orthobiosis (UsageWeight:100; CharacterWeight:90)
10. Line: orthocephalic (UsageWeight:100; CharacterWeight:70)
11. Line: orthocephalous (UsageWeight:100; CharacterWeight:60)
12. Line: orthochorea (UsageWeight:100; CharacterWeight:90)
13. Line: orthochromatic (UsageWeight:100; CharacterWeight:60)
14. Line: orthochromia (UsageWeight:100; CharacterWeight:80)
15. Line: orthochromic (UsageWeight:100; CharacterWeight:80)
16. Line: orthochromophil (UsageWeight:100; CharacterWeight:50)
17. Line: Orthoclone (UsageWeight:100; CharacterWeight:100)

Due to the fact that more than three (3) exact matches were located in the primary specialty dictionary 16, no corrective suggestions were sought.

The results from predictive suggestions of the primary specialty dictionary 16 are then combined and ordered by weight. In the example above, the usage weight and the character weight are added together for a combined weight score. The top 10 results are then compiled and ordered from largest to smallest:
1. Completion Result:[WordListResult] word: ortho (weight:300)
2. Completion Result:[WordListResult] word: orthopedic (weight:270)
3. Completion Result:[WordListResult] word: orthopedics (weight:240)
4. Completion Result:[WordListResult] word: orthopaedics (weight:230)
5. Completion Result:[WordListResult] word: orthesis (weight:220)
6. Completion Result:[WordListResult] word: orthetic (weight:220)
7. Completion Result:[WordListResult] word: orthodox (weight:220)
8. Completion Result:[WordListResult] word: orthopia (weight:220)
9. Completion Result:[WordListResult] word: orthopod (weight:220)
10. Completion Result[9]:[WordListResult] word: orthosis (weight:220)

In the present example, the algorithm 18 then determines whether to provide a corrective suggestion, a predictive suggestion or a combination thereof. The algorithm 18 detects whether any of the words from the primary specialty dictionary 16 exactly match the letters entered. In the event that three (3) or more words in the specialty dictionary 16 exactly match the letters input by the user, corrective words are not suggested, and only predictive suggestions are provided. Since more than three (3) exact matches exist in the present example, the top three (3) results from the completion results are provided in the ribbon. In the present example, the system is programmed such that the first word provided is the top weighted suggestion from the primary specialty dictionary 16, and the second example is provided from the top suggestion from the Apple SDK results. The third completion suggestion is again provided from the primary specialty dictionary 16. However, since the top result from the Apple SDK results matches the second suggestion from the primary specialty dictionary 16, the algorithm 18 provides the third completion suggestion from the primary specialty dictionary 16 instead.

The final suggestions are as follows:
1. Ortho
2. Orthopedic
3. Orthopedics

A screen shot from a beta tester for the above example is provided in FIG. 4 showing one manner in which the user inputs and suggestions can be laid out on a user interface 12 of a mobile device 10.

Referring now to FIG. 5, a second illustrative example is provided that also utilizes a single ribbon 22 and provides both predictive and corrective text suggestions. The ribbon 22 has the ability to provide up to three (3) total suggestions at a time. In the second example, like the first example, a publicly available resource for app developers was utilized to provide both predictive and corrective standard dictionary 14 suggestions. Also similar to the first example, a bespoke listing of medical terminology was compiled to serve as primary specialty dictionary 16 for the present example. The primary specialty dictionary 16 was accessed remotely from the mobile device. In similar fashion to the first example, two (2) criteria are used to provide weight to the words in the primary specialty dictionary 16: 1) usage weight and 2) word length. The algorithm 18 iterates through the specialty dictionary and searches for each word that starts with the letters entered by the user and applies a usage weight to each matching result. Usage weight is ascribed by its overall likelihood of use. In this second example, words in the primary specialty dictionary have been provided with a weight ranging between 100 and 170. Character weight is determined by lower character counts having a higher weight due to shorter words generally being more likely due to standard patterns of language. In the event the weights of two words are the same, the words are ordered in alphabetical order.

For correction determination, the algorithm 18 iterates through the primary specialty dictionary 16 and assigns weights to words based on usage weight (which carries the same value as provided above with respect to predictive suggestions) and corrective weight. Corrective weight is ascribed by character placement and character neighbor accuracy.

When a user types on the keyboard 20 of the user interface 12, for example, the letters “Orthopwd”, the algorithm 18 provides results for the standard Apple Correction results from the Apple SDK and the Standard Apple Completion from Apple SDK.

The Standard Apple Correction from Apple SDK is as follows:
1. No Correction Results

The Standard Apple Completion from Apple SDK is as follows:
1. No Completion Results

The matches from the primary specialty dictionary 16:
1. No Completion Results

Due to the fact that less than three (3) exact matches exist in the primary specialty dictionary 16 compared to the letters input by the user, the algorithm 18 then looks for corrective words to suggest instead. The following correction determinations were then located:
1. Line: orthopaedics CorrectionWeight:700 UsageWeight:150
2. Line: orthopedic CorrectionWeight:750 UsageWeight:170
3. Line: orthopedics CorrectionWeight:730 UsageWeight:150
4. Line: orthopedist CorrectionWeight:730 UsageWeight:100
5. Line: orthopod CorrectionWeight:700 UsageWeight:100

The corrective results from the primary specialty dictionary 16 are then combined and ordered by weight. In the example above, the correction weight and the character weight are added together for a combined weight score. The top 5 results are then compiled:
1. Correction Result[0]:[WordListResult] word:orthopedic weight:920
2. Correction Result[1]:[WordListResult] word:orthopedics weight:880
3. Correction Result[2]:[WordListResult] word:orthopaedics weight:850
4. Correction Result[3]:[WordListResult] word:orthopedist weight:830
5. Correction Result[4]:[WordListResult] word:orthopod weight:800

In similar fashion to the first example, the algorithm 18 determines whether to provide a corrective suggestion, a completion or a combination. The algorithm 18 detects whether any of the words from the primary specialty dictionary 16 exactly match the letters entered. In the event that three (3) or more words in the specialty dictionary 16 exactly match the letters provided by the user, corrective words are not suggested and only completions suggestions are provided. Since no exact matches exist in the present example, only corrective results are displayed.

In order to provide the user with an efficient method to override any suggested corrections, the first result is provided as the already-typed letters provided in quotes. The second result is the top corrective word provided by the Apple SDK. In the present instance, there are no suggestions, so the second and third corrective suggestions are provided as the top two (2) corrective suggestions from the primary specialty dictionary 16.

The final suggestions are as follows:
1. “Orthopwd”
2. Orthopedic
3. Orthopedics

A screen shot from a beta tester is provided in FIGS.

In addition to the suggestive and corrective suggestions provided in the ribbon 22, the ribbon(s) 22 may also provide additional functionality, such as specialty buttons. The smart buttons can provide the user with options for retrieving additional information, accessing bespoke data entry fields, providing internet links.

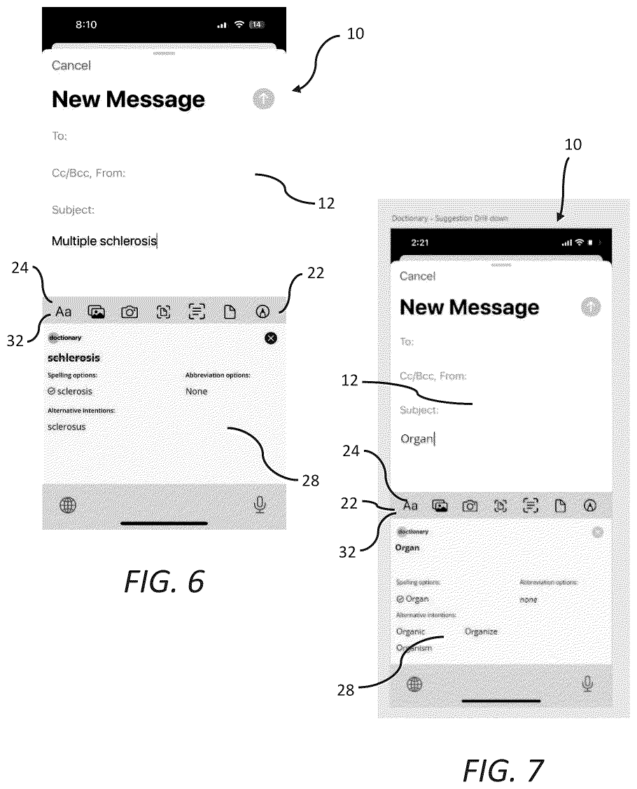

Referring now to FIGS. 2-3, and 6-7, the ribbon 22 may include a specialty button that, e.g., enables a user to expand upon the results provided in the ribbon during typing. For example, in FIGS. 2-3, the first ribbon 34 includes an specialty button on the left-hand side that includes a logo for “Doctionary.” As can be seen in both FIGS. 2 and 3, the user is receiving either corrective or predictive suggestions as feedback in response to typing. In addition, to the user-readable and/or user-selectable options provided within the ribbon, it may be desirable for the user to access additional information and/or suggestions. For example, as shown in FIGS. 6 and 7, the user, upon selecting the specialty button, it taken to a pop-up window 28 that provides an expanded area in which information can be provided to the user. Useful information can include, additional corrective and/or predictive suggestions (see FIG. 6 and FIG. 7, respectively) or may provide definitions for the words. Alternatively, although not shown, if the word is a, e.g., a proper name for a pharmaceutical drug, the specialty button can be utilized to deliver additional drug information from the pharmaceutical company and/or advertisements.

Additionally, in certain specialty fields, certain data is communicated in certain industry standard formats. One example is the vitals schema of a medical patient. Another example is a lab skeleton for sharing lab data. In these examples, the user would be provided data entry fields on the skeleton or vitals schema that can be filled in by the user and then the partially or fully completed data entry fields can be sent in the electronic communication. In some embodiments, it may be advantageous to convert the partially or fully filled in data entry fields to an image prior to sending.

In a second embodiment, the app of the present invention can be realized in a stand-alone app that is either dedicated to communications or is a multi-faceted app that includes a dedicated communication function therein. In this embodiment, the app would still include generally the same features as described above in connection with the first embodiment; however, rather than altering the keyboard 20 and communications functions that are provided with the mobile device 10, the app could provide a stand-alone, full-featured communications package along with (optionally) additional functionality. In this embodiment, the communications can more easily be encrypted and the user can, for example, more easily separate industry-specific communications from everyday communications.

In a third embodiment, the present invention can be an enhancement of a communication feature of a third-party stand-alone application. For example, there are well-know applications that utilize a keyboard 20 to facilitate electronic communications of various types. The present invention may be used to enhance the user experience of these communications, as well.

In operation, the present invention provides an enhancement to the predictive and/or corrective suggestions to a user as he or she inputs letters (or numbers, symbols, etc.) into a mobile device 10 using a keyboard 20. The algorithm 18 of the present invention compares the data entered by the user to at standard dictionary 14 and a primary specialty dictionary 16. In some embodiments, the algorithm 18 may further compare the data entered by the user to a secondary specialty dictionary 26. The algorithm 18 compares the data entered to the standard dictionary 14 to identify, and provide a weighted score to using predetermined criteria, words that are direct matches (for predictive suggestions), or words that are close matches (for corrective suggestions). The algorithm 18 likewise similarly compares the data entered to the primary specialty dictionary 16 to identify and provide a weighted score to using pre-determined criteria, words that are direct matches (for predictive suggestions), or words that are close matches (for corrective suggestions). The algorithm 18, based on the results, determines whether to provide corrective suggestions, predictive suggestions, or a combination thereof. As previously discussed, the suggestions provided can depend on the number of exact matches located in one or more of the dictionaries 14, 16. For example, if no exact matches are located, then corrective suggestions are provided. If many (e.g., more than three (3)) exact matches are located, then the predictive suggestions may be provided. If a few (e.g., between one (1) and three (3)) exact matches are located, then a combination of predictive suggestions and corrective suggestions may be provided. Once the suggestions are identified, they are provided to the user in, e.g., the ribbon adjacent the keyboard. The user may elect to select the suggestion for the word to be entered into the electronic communication in place of what has been typed, or the user may elect to ignore the suggestion(s) and simply continue typing. Refreshed suggestions are provided with each new piece of data entered by the user.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A system for providing suggested text in a digital communication, comprising:
a mobile device having a user interface with a keyboard and a ribbon;
a first dictionary, the first dictionary being a standard dictionary; and
a second dictionary, the second dictionary being a primary specialty dictionary;
wherein a suggested text is provided to a user based on a user keyboard input, the suggested text being at least one of a corrective suggestion or a predictive suggestion;
wherein the suggested text is provided in the ribbon; and
wherein at least one of the corrective suggestion or the predictive suggestion is a word provided from the second dictionary.

2. The system for providing suggested text in a digital communication of claim 1, wherein the digital communication is an email.

3. The system for providing suggested text in a digital communication of claim 1, wherein the digital communication is a text message.

4. The system for providing suggested text in a digital communication of claim 1, wherein the digital communication is a direct message.

5. The system for providing suggested text in a digital communication of claim 1, wherein the digital communication is a note to a record.

6. The system for providing suggested text in a digital communication of claim 1, wherein the suggested text includes more than one corrective suggestion.

7. The system for providing suggested text in a digital communication of claim 1, wherein the suggested text includes more than one predictive suggestion.

8. The system for providing suggested text in a digital communication of claim 1, wherein the suggested text includes at least one corrective suggestion and at least one predictive suggestion.

9. The system for providing suggested text in a digital communication of claim 1, wherein the corrective suggestion is provided after the system determines that the user input does not match a single entry in the second dictionary.

10. The system for providing suggested text in a digital communication of claim 1, wherein the predictive suggestion is provided after the system determines that the user input matches one or more entries in the second dictionary.

11. A method for providing a suggested text in a digital communication, comprising:
receiving user input on a mobile device through use of a keyboard on a user interface;
comparing the user input to the words in a first dictionary, the first dictionary being a standard dictionary;
comparing the user input to the words in a second dictionary, the second dictionary being a primary specialty dictionary;
creating a weighted scoring of the words in at least the second dictionary based on at least one pre-determined criteria;
providing the suggested text in a ribbon on the user interface, the suggested text being at least one of a predictive suggestion or corrective suggestion.

12. The method of claim 11 wherein the corrective suggestion is provided at times when the user input matches fewer than two entries in the second dictionary.

13. The method of claim 11, wherein the predictive suggestion is provided at times when the user input matches more than one entry in the second dictionary.

14. The method of claim 11, wherein more than one predictive suggestion is provided, and at least one of the predictive suggestions is provided from the first dictionary, and at least one of the predictive suggestions is provided from the second dictionary.
